(19) United States
(12) Patent Application Publication
(10) Pub. No.: US 2008/0205700 A1
(43) Pub. Date: Aug. 28, 2008

(54) Apparatus and Method for Assisted Target Designation

(76) Inventor: Tal Nir, Haifa (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 11/912,149

(22) PCT Filed: Apr. 11, 2006
(86) PCT No.: PCT/IL0606/000469

§ 371 Date: May 6, 2008

(30) Foreign Application Priority Data
Apr. 21, 2005 (IL) 168210

(51) Int. Cl. G06K 9/00

(52) U.S. Cl. 382/103

(57) ABSTRACT

A method for assisting a user to designate a target as viewed on a video image displayed on a video display by use of a user operated pointing device. The method includes the steps of evaluating prior to target designation one or more tracking function indicative of a result which would be generated by designating a target at a current pointing direction of the pointing device, and providing to the user, prior to target designation, an indication indicative of the result.

### FIELD AND BACKGROUND OF THE INVENTION

The present invention relates to designation of targets in video images and, in particular, it concerns an apparatus and method for facilitating selection of targets, particularly under conditions of motion or other impediments which interfere with target designation.

Many navigation systems, surveillance systems and weapon systems provide a user with a video image of a region of interest from which the user may wish to designate an object or feature for tracking. In a typical tracker, the user selects the desired target and the target is from that point onwards tracked automatically. Known techniques for video-based target designation employ a user-operated pointing device (e.g., joystick, trackball, helmet-mounted sight, eye-tracking system etc.) to either move a cursor/marker or move a gimbal on which the camera is mounted so that a marker (e.g. a crosshair) is located on the desired target on the live video display. Then, by pushing a button, the user finally locks the tracker on the current target. A tracking module is then actuated and attempts to reliably acquire a trackable target at the designated position within the image for subsequent automated tracking.

In many cases, there are many possible locations on the target at which the user can lock the tracker. The specific location selected within a target might have major influence on the tracking performance and on the probability of target tracking success. Thus, an attempt to designate a valid target may fail due to the inability of a tracking module to find a reliably trackable feature at the designated image location. For example, where the selected region lacks sufficient spatial variation (contrast) in one direction (such as along the edge of a wall), or contains repetitive patterns or the like, a reliable tracking “lock-on” often cannot be achieved. In such cases, the user may make repeated attempts to designate a desired target until happening upon a part of the target object which is sufficiently distinctive to allow reliable tracking.

The problem of target designation is further exacerbated where the user and/or the imaging sensor are on an unsteady moving platform such as a moving vehicle, particularly, an off-road vehicle, an aircraft or a boat which may be subject to vibration, angular oscillation and/or generally unpredictable motion resulting from rough terrain, climatic disturbances and/or motion due to wind or waves. This is particularly true for small (for example, unmanned) vehicles which are more severely affected by disturbances (terrain, waves, wind, etc. . . . ). Similar problems exist in the case of remotely-guided missiles and bombs where the operator is required to lock-on to a target in a video image relayed from a camera mounted on the missile or bomb during flight. In such cases, the user has the difficult task of trying to select a point of interest as it oscillates, vibrates or otherwise moves around the field of view.

There is therefore a need for an apparatus and method for facilitating designation of a target within a video image which would make the locking process easier, faster and more fool proof.

### SUMMARY OF THE INVENTION

The present invention is an apparatus and method for facilitating designation of a target within a video image.

According to the teachings of the present invention there is provided, a method for assisting a user to designate a target as viewed on a video image displayed on a video display by use of a user operated pointing device, the method comprising the steps of: (a) evaluating prior to target designation at least one tracking function indicative of a result which would be generated by designating a target at a current pointing direction of the pointing device; and (b) providing to the user, prior to target designation, an indication indicative of the result.

According to a further feature of the present invention, the indication is a visible indication presented to the user on the video display.

According to a further feature of the present invention, the indication is an audible indication.

According to a further feature of the present invention, the tracking function is a trackability function indicative of the capability of a tracking system to track a target designated at the current pointing direction.

According to a further feature of the present invention, the tracking function is an object contour selector, and wherein the user-visible indication indicates to the user a contour of an object in the video image which would be selected by designating a target in the current pointing direction.

According to a further feature of the present invention, the tracking function is a result of a classifier used to identify specific objects appearing within the video image.

According to a further feature of the present invention, if the tracking function takes a value in a predefined range of values, the indication indicates to the user an inability to designate a target at a current pointing direction of the pointing device.

There is also provided according to the teachings of the present invention, a method for assisting a user to designate a target as viewed on a video image displayed on a video display by use of a user operated pointing device, the method comprising the steps of: (a) for at least a region of the video image adjacent to a current pointing direction of the pointing device, evaluating a trackability function at a plurality of locations to derive suggested trackable image elements; (b) in response to a selection input, designating a current tracking image element within the video image corresponding to one of the suggested trackable image elements proximal to the current pointing position of the pointing device; and (c) tracking the current tracking image element in successive frames of the video image.

According to a further feature of the present invention, the trackability function is a score from an object identifying classifier system.

According to a further feature of the present invention, if no suggested trackable image element is derived within the region, designation of a current tracking image element is prevented.

There is also provided according to the teachings of the present invention, a method for assisting a user to designate a target as viewed on a video image displayed on a video display by use of a user input device, the method comprising the steps of: (a) for at least one region of the video image, evaluating a trackability function at a plurality of locations to derive suggested trackable image elements within the region; (b) if at least one suggested trackable image element has been derived, in dictating a position of the at least one suggested trackable image element in the video display; (c) receiving an input via a user input control to select one of the suggested trackable image elements, thereby designating a current tracking image element.

According to a further feature of the present invention, the user input control is a non-pointing user input control.

According to a further feature of the present invention, prior to the receiving, the suggested trackable image elements are tracked in successive frames of the video image and the position of the at least one trackable image element continues to be indicated in the video image.

According to a further feature of the present invention, if a plurality of suggested trackable image elements has been derived, the positions of the plurality of suggested trackable image elements are indicated on the video display.

According to a further feature of the present invention, the at least one region of the video image is defined as a region satisfying a given proximity condition to a current pointing direction of a pointing device controlled by the user.

According to a further feature of the present invention, the at least one region of the video image includes substantially the entirety of the video image.

According to a further feature of the present invention, the indicating a position of the at least one suggested trackable image element in the video display includes displaying an alphanumeric label associated with each of the suggested trackable image elements, and wherein the non-pointing user input control is a keyboard allowing selection of an alphanumeric label.

According to a further feature of the present invention, if no suggested trackable image element is derived within the region, designation of a current tracking image element is prevented.

### BRIEF DESCRIPTION OF THE DRAWINGS

The invention is herein described, by way of example only, with reference to the accompanying drawings, wherein:

FIG. 1 is a schematic diagram of a system, constructed and operative according to the teachings of the present invention, for assisting a user to designate a target as viewed on a video image displayed on a video display;

FIG. 2 is a flow diagram illustrating a first mode of operation of the system of FIG. 1;

FIG. 3 is a flow diagram illustrating a second mode of operation of the system of FIG. 1;

FIG. 4 is a flow diagram illustrating a third mode of operation of the system of FIG. 1;

FIG. 5 is a photographic representation of a video frame used to illustrate the various modes of operation of the present invention;

FIGS. 6A-6D illustrate a display derived from the frame of FIG. 5 according to an object contour tracking implementation of the mode of operation of FIG. 2 in which the user receives feedback regarding the contour of the recognized object at which the crosshair is currently pointing;

FIGS. 7A-7C show applications of the mode of operation of FIG. 4 applied to the frame of FIG. 5 with three levels of localization of the processing; and

FIGS. 8A and 8B show two modified displays derived from the frame of FIG. 5 indicative of a trackability function wherein brighter locations indicate better trackability.

### DESCRIPTION OF THE PREFERRED EMBODIMENTS

The present invention is an apparatus and method for facilitating designation of a target within a video image.

The principles and operation of apparatuses and methods according to the present invention may be better understood with reference to the drawings and the accompanying description.

### System Overview

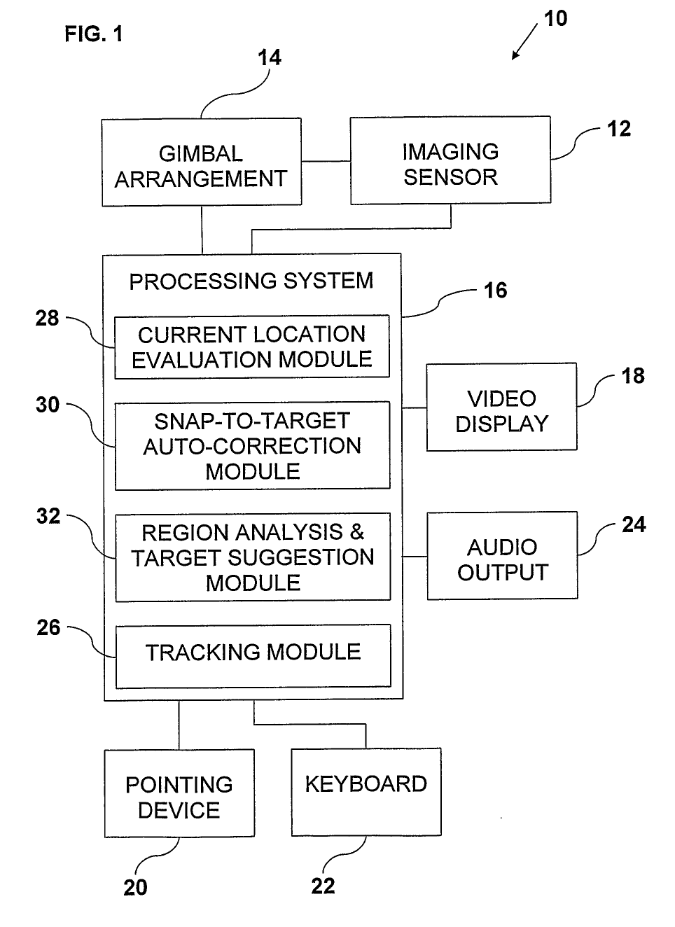

Referring now to the drawings, FIG. 1 shows schematically the components of a preferred implementation of a tracking system, generally designated 10, constructed and operative according to the teachings of the present invention, for assisting a user to designate a target as viewed in a video image. Generally speaking, system 10 includes an imaging sensor 12 which may be mounted on a gimbal arrangement 14. Imaging sensor 12 and gimbal arrangement 14 are associated with a processing system 16 which includes a plurality of modules to be described below. Images from the imaging sensor are displayed on a video display 18. Further user input and/or output devices preferably include one or more of a pointing device 20, a non-pointing input device such as a keyboard 22, and an audio output device 24.

Processing system 16 includes a tracking module 26 which provides tracking functionality according to any known tracking methodology. In addition to tracking module 26, processing system preferably includes one or more additional module selected from: a current location evaluation module 28; a snap-to-target auto-correction module 30; and a region analysis and target suggestion module 32. The functions and implementations of these various modules will be discussed further below.

### System Components

It will be clear to one ordinarily skilled in the art that the principles of the present invention as claimed are applicable to substantially any system in which a user is required to designate a target viewed on a video display for subsequent automatic tracking. Thus, system 10 may be implemented using many different components, various system architecture, and may be adapted to a wide range of different applications, not limited to the specific examples mentioned herein.

Imaging sensor 12 may be any sensor or combination of sensors which generates a video image of a region of interest. Examples include, but are not limited to: CCD's and other imaging devices for visible light; and thermal imaging sensors. Video images are typically generated by staring sensors although, in some circumstances, scanning sensors may also be relevant.

Imaging sensor 12 may be mounted at a fixed location or may be mounted on a moving platform such as a land, maritime or airborne vehicle. The imaging sensor may be in fixed relation to its platform in which case no gimbal arrangement is required. This option is particularly relevant to fixed surveillance systems where one or more staring imaging sensor gives coverage of a pre-defined region of interest. In other applications, imaging sensor 12 may be mounted on a gimbal arrangement 14 which may be dedicated just to imaging sensor 12 or may be common to other components or devices which move together with the imaging sensor. Gimbal arrangement 14 may optionally be a stabilized gimbal arrangement. Depending upon the specific application, gimbal arrangement 14 may optionally be manually controlled and/or may be controlled under closed loop feedback by tracking module 26 to follow a tracked target during active tracking.

Processing system 16 may be any suitable processing system based on one or more processors, and may be located in a single location or subdivided into a number of physically separate processing subsystems. Possible implementations include general purpose computer hardware executing an appropriate software product under any suitable operating system. Alternatively, dedicated hardware, or hardware/software combinations known as firmware, may be used. The various modules described herein may be implemented using the same processor(s) or separate processors using any suitable arrangement for allocation of processing resources, and may optionally have common subcomponents used by multiple modules, as will be clear to one ordinarily skilled in the art from the description of the function of the modules appearing below.

It will be noted that tracking module 26 would, according to conventional thinking, generally be idle prior to designation of a target for tracking. Most preferably, the present invention utilizes the previously untapped processing power of the tracking module during the period prior to target designation to provide the pre-target-designation functions of one or more of modules 28, 30 and 32.

Video display 18 may be any suitable video display which allows a user to view a video image sequence. Suitable displays include, but are not limited to, CRT and LCD screens, projector systems, see-through displays such as a head-up display (HUD) or helmet-mounted display (HMD), and virtual displays such as direct retinal projection systems.

Pointing device 20 may be any user-operated pointing device including, but not limited to, a joystick, a trackball, a touch-sensitive screen, a set of directional “arrow” cursor control keys, a helmet-mounted sight, and an eye-tracking system. As will be discussed below, at least one mode of operation of system 10 may essentially render pointing device 20 completely redundant. In most cases, however, it is desirable to allow the user to select one of a number of different modes of operation, such that a pointing device is typically provided.

Parenthetically, it should be noted that the terms “pointing direction” and “pointing position” are used interchangeably in this document to refer to the position of a cursor, selection point, cross-hair or the like in the display of the video image. The position is referred to as a pointing “direction” to convey the fact that the selection point in the image corresponds uniquely to a direction in three-dimensional space relative to the imaging device geometry.

It is a particular feature of certain implementations of the system and corresponding methods of the present invention that at least one mode of operation allows designation of a target within the video image by use of a non-pointing input control. The phrase “non-pointing input control” is used herein in the description and claims to refer to an input control, such as a button, switch or other sensor operable by a user which is not, per se, indicative of a direction within the video image and which is effective even when the target designated does not correspond exactly to the current pointing direction of a pointing device. It is important to note that the non-pointing input control may itself be part of an input device which does include a pointer. Thus, examples of a non-pointing input control include control buttons on a joystick or keys of a keyboard 22 even if the keyboard also includes an integrated pointing device.

Preferably, keyboard 22 or other similar input device also includes input controls for allowing the user to activate one or more of a number of the modes of operation described herein.

Finally with regard to the system components, it should be noted that system 10 may be implemented either as a self-contained local system or in the context of a remotely controlled system. In the latter case, imaging sensor 12 and gimbal arrangement 14 are located on the remotely controlled platform while display 18, input devices 20 and 22, and audio output 24 are located at the operator location. The processing system 16 may be located at either the operator location or on the remotely controlled platform, or may be distributed between the two locations. The linkage between the two parts of the system is implemented by use of a wireless communication link of any suitable type, as is well known in the art.

### Current Location Evaluation Module

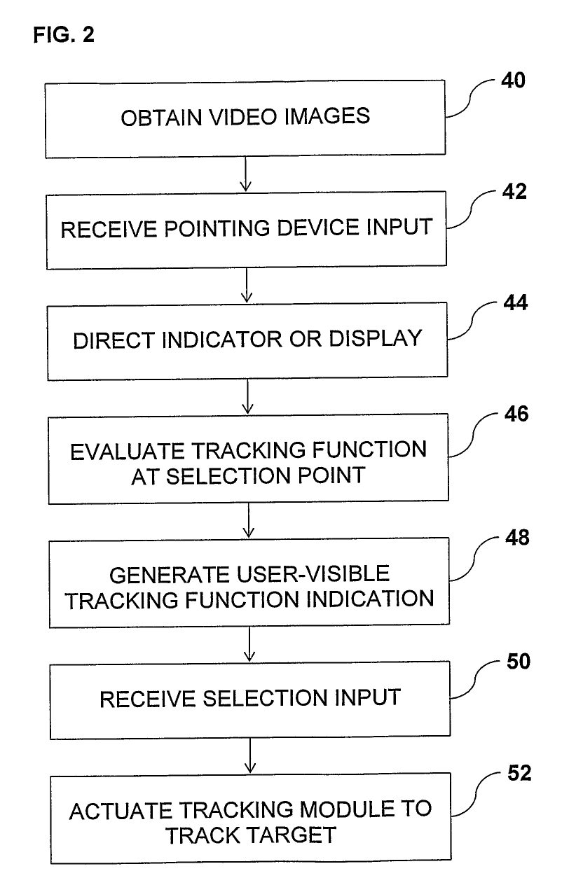

Turning now to the details of the modules of processor system 16, module 28 is referred to as a “current location evaluation module”. The preferred operation of this module and a corresponding aspect of the method of the present invention is illustrated in FIG. 2.

Referring now to FIG. 2, operation begins by obtaining the video images from imaging sensor 12 (step 40), receiving a pointing device input (step 42) and directing an indicator within the display, or the optical axis of the imaging sensor field of view, according to the pointing device input (step 44). Steps 40, 42 and 44 together essentially provide the conventional functionality of a user-steerable selection point (cursor, cross-hair or the like) within a video image, or of a steerable optical axis of the imaging device with a fixed cross-hair. It should be noted that both of these options are referred to herein in the description and claims as “directing an indicator within the display” since the overall effect of both is that the user controls the spatial relationship between the selection point and the objects visible in the video image.

In contrast to conventional systems, at step 46, this module evaluates, prior to target designation, at least one tracking function indicative of a result which would be generated by designating a target at a current pointing direction of the pointing device. At step 48, an indication is provided to the user, still prior to target designation, indicative of the result. The indication provided may be shown within the context of the video image by any suitable technique. Examples of suitable display techniques include, but are not limited to: changing the color or brightness of the designation symbol on the display or causing it to flash; turning on and off graphical markers; designating an object pointed out by the crosshair (e.g. by highlighting the contour of the object); and indicating next to the designation symbol a numerical score indicative of the suitability of the current pointing direction for lock-on and tracking. Alternatively, the indication may be provided as audio feedback to the user. In any case, the feedback to the user provides an advance indication to the user as he or she hovers over features appearing in the live video image with the designation cursor (or line of sight) as to whether the features are good or poor candidates for locking-onto by the automatic tracking system, thereby greatly facilitating the user selection of a suitable feature. Then, when ready, the user supplies a designation input to designate a target in the current pointing direction (step 50) and tracking module 26 then proceeds to acquire and automatically track the target (step 52). The designation input may be supplied in a conventional manner, such as via a button or trigger associated with the pointing device. Optionally, where the tracking function evaluation is indicative that the features at the current pointing direction are poor candidates for reliable tracking (e.g., when the tracking function evaluation produces an output below a certain threshold value indicating a high probability that ongoing tracking will fail), the system may block selection by the user, even if short-term lock-on is currently possible, thereby making the system more fool proof. According to a further option, the “snap to target” algorithm described below may be invoked in such cases.

The term “tracking function” is used here to refer to any function or operator which can be applied to a locality of the video image, either at the display resolution or more preferably at the native resolution of the imaging device, to produce an output useful in assessing the expected result of an attempt to designate a target in the corresponding locality of the video display. Optionally, the tracking function may employ, or be derived from, components of the tracking module 26.

According to one particularly preferred set of implementations, the tracking function is a “trackability function” indicative of the capability of a tracking system to track a target designated at the current pointing direction. In certain cases, existing subcomponents of the tracking module 26 may generate a numerical output suitable for this purpose. In other cases, it may be preferable to define a trackability function which directly evaluates one or more property of the location of the image which is known to be indicative of the likelihood of successful tracking of the local features. Examples of properties which may be used in evaluation of trackability include, but are not limited to:
1. Contrast: Locations with high contrast are typically preferred. However, high contrast may not be enough. For example, if the contrast is only in one direction, the motion orthogonal to this direction will not be noticeable. Therefore, contrast in at least two directions is desirable. The measure of contrast versatility in a neighborhood is typically referred to in the literature as “cornerness”. There are several methods in the literature for automatic detection of corners in images. Typically, the measures refer to the ability to detect changes of the image patch under a certain class of transformation (e.g. translation, similarity, affine, etc. . . . ). These measures can be matched to the class of transformations taken into account by tracking module 26. Further details of algorithms for this purpose may be found in the paper: “Good Features To Track”, by Shi and Tomasi (IEEE Conference of Computer Vision and Pattern Recognition (CVPR94), Seattle, June 1994) which is hereby incorporated by reference. After the selection of a cornerness criterion, this criterion will be used in the evaluation of the user's current target. Local maxima of the criterion will be offered as suggestions (in the subsequent modes of operation described below) for alternative good locking locations.
2. Uniqueness: It is also desirable to lock the tracker on a unique feature. An image region might be a good corner as described above, but might belong to a repeated pattern or “texture” in the scene which can confuse the tracker, especially under occlusions and changes of the viewpoint. A good measure of uniqueness might use the ratio between the tracking criteria (e.g. correlation, sum of squared differences, etc. . . . ) evaluated on the potential target relative to the tracking criterion evaluated in other locations in the image. If the target is unique, then the criteria on the target will be significantly different from the criteria measured in any other location in the image.
3. Automatic Target Recognition (ATR): If the tracker is intended for tracking particular types of objects such as: vehicles, ships, airplanes, etc., a classifier can be used within the framework of an expert system designed to find particular objects of interest from their image appearance. In this case, the classifier score can be used as a replacement for, or in addition to, the aforementioned trackability measures prior to target tracking. In this case, the preferred locations for tracker lock would be image elements with a high classifier score, i.e., that resemble the objects of interest as interpreted by the classifier. The incorporation of a classifier prior to target lock can be used when the tracker is a general purpose tracker or when the tracker itself uses a classifier, in which case, the same type of classifier would preferably be used for evaluation of image locations prior to target lock.

Optionally, the system and method may continue to indicate to the user the “quality” of the target for tracking even after lock-on while tracking module 26 is operating. In this case, the system may serve as a warning of deteriorating tracking reliability prior to failure of the tracking, thus giving the operator time to adjust the lock-on to a more reliably trackable feature of the target or temporarily switch to manual control.

Parenthetically, while the present invention is described herein primarily with reference to tracking techniques known as “feature tracking”, it should be noted that it is also considered applicable to a wide range of other tracking methodologies. By way of one non-limiting example, FIGS. 6A-6D illustrate an application of the local evaluation module 30 in the context of a classifier-based tracking system which identifies and tracks two-dimensional or three-dimensional elements within the live video image. In this case, the tracking function is preferably an object contour selector or classifier which locates and optionally also classifies objects within the images. By way of non-limiting examples, such systems may be based two-dimensional image-processing algorithms, may be expert systems performing classification of objects into classes or types based on a learning process (e.g., using neural networks), or may perform matching of image elements to a reference database of three-dimensional objects of interest. The user-visible indication then indicates to the user an object in the video image which would be selected by designating a target in the current pointing direction, typically either by highlighting a contour (outline) of the object or by labeling the object with its classifier name.

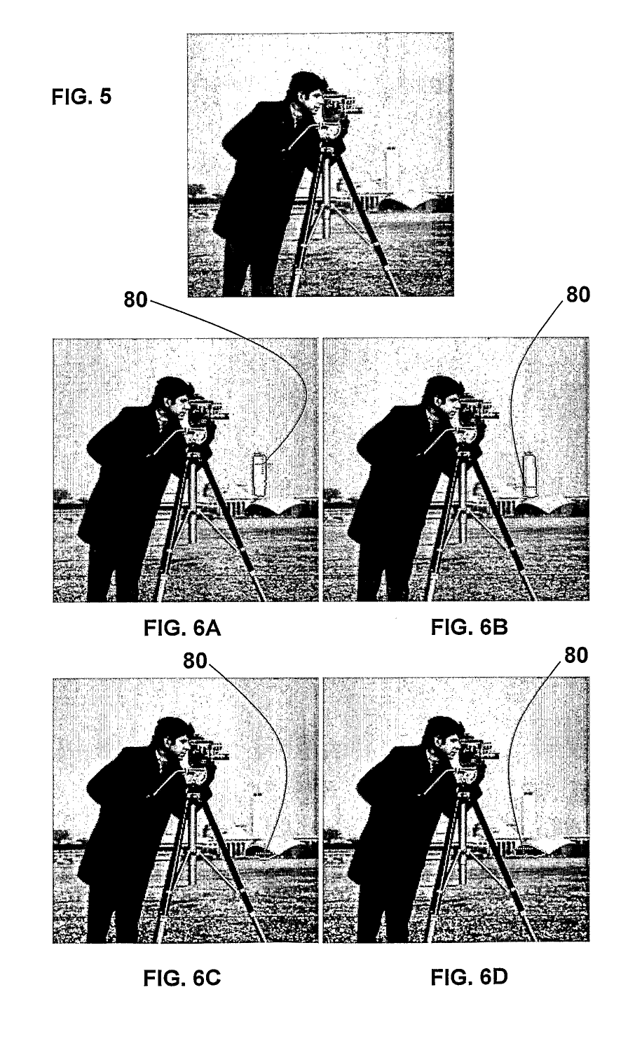

This functionality is illustrated schematically in FIGS. 6A-6D in the context of a single frame, shown in original version in FIG. 5, which is used schematically herein to illustrate the operation of the present invention. In FIG. 6A, a cross-hair designated 80 is located overlying a top-right region of a tall building appearing in the background. When the cross-hair is positioned in this location, the object contour selector (classifier) determines the contour of the object, in this case the entire building, which would be selected if the user were to operate the tracking actuation control with the pointing device in this pointing direction/location. The object is then highlighted in real-time in the display, allowing the user to see clearly what object would be selected if he or she were to actuate tracking at this point. In FIG. 6B, the cross-hair has been moved to the lower left region of the same building. Since it still lies within the boundary of the same object and therefore results in the substantially the same object boundary being displayed, thereby indicating that the effect of user selection at that location would be substantially the same as in FIG. 6A. Similarly, FIGS. 6C and 6D illustrate two different cross-hair positions both of which result in highlighting of the same side of a low building, thereby indicating that the same object would be selected and tracked by actuating the tracking control input in either of these positions.

The term “image element” is used herein, independent of the tracking methodology used, to refer to the location, feature, region or object upon which a tracking module (and corresponding trackability evaluation function) operate.

### “Snap-To-Target” Module

The modes of operation described thus far relate to evaluation of a tracking-related function at the current pointing direction of a user operated pointing device. In most preferred implementations of the present invention, additional enhancements to the target selection procedure are provided by evaluating a tracking related function in real-time over at least one region of the live video image not limited to the current pointing direction.

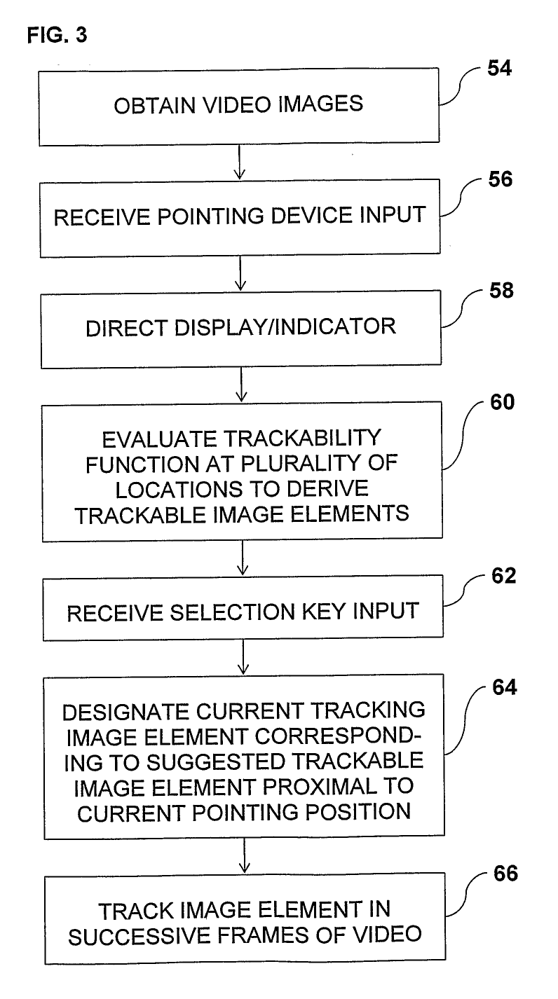

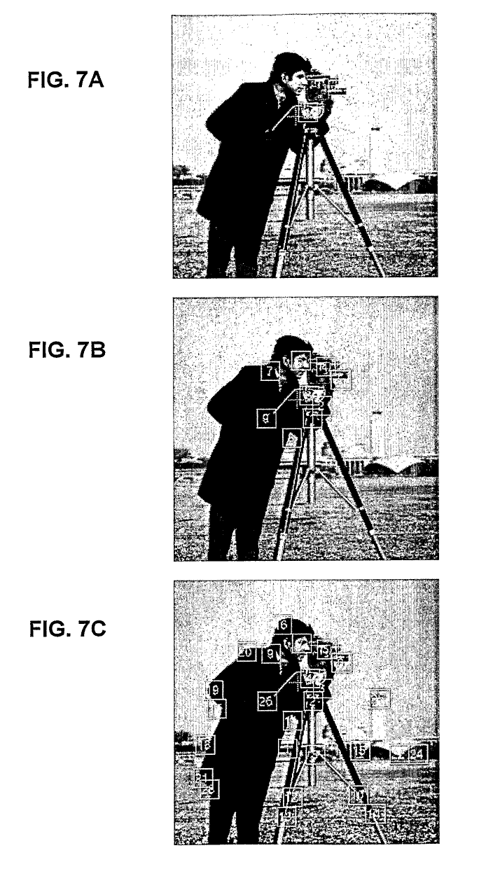

By way of a first example, the operation of “snap-to-target” auto-correction module 30 will now be described with reference to FIGS. 3 and 7A. In general terms, this module operates by evaluating a trackability function in a region around the current pointing direction and “snaps” the target selection on operation of a selection input to the best-trackable target proximal to the current pointing direction. This provides a functionality comparable to the “snap-to-grid” option provided in certain drawing software programs whereby a precise location can be reliably and repeatably selected using relatively low-precision control of a pointing device since the selection operation “snaps” to the nearest gridpoint. In the present context, provision of this function in the context of a real-time video image greatly facilitates rapid selection of a reliably trackable feature in the moving image. The overall effect of this mode of operation may be appreciated with reference to FIG. 7A wherein selection of a target at the current cross-hair position (which lies in a dark featureless region unsuited for tracking) may result in selection of the location marked with the symbol [symbol] (In most cases, the [symbol] symbol is not actually displayed in this mode of operation.)

Turning now specifically to FIG. 3, this starts with steps 54, 56 and 58 which parallel steps 40, 42 and 44 of FIG. 2, providing pointing direction control within the video image. At step 60, the module evaluates a trackability function at a plurality of locations to derive at least one suggested trackable image element. After receipt of a selection key input (step 62), the module designates a current tracking image element within the video image corresponding to one of the suggested trackable image elements proximal to the current pointing position of the pointing device (step 64) which is then tracked dynamically in subsequent frames (step 66).

The trackability functions used for this implementation are typically similar to those described above in the context of FIG. 2. The evaluation step 60 may be performed either continuously prior to actuation of a selection key, or may be initiated by the operation of selecting a target. The processing and corresponding algorithms for selecting the target location may be implemented in various ways, as will be clear to one ordinarily skilled in the art. By way of non limiting examples, two methodologies will be outlined below.

According to a first methodology, processing may be rendered very simple and rapid by evaluating the trackability function at locations at and around the current pointing direction and following a direction of increase (i.e., improved trackability) until a local maximum of the trackability function is found. In a modification of this approach, evaluation may expand radially from the selection point until the local maximum of the trackability function closest to the selection point is found. These approaches are particularly, although not exclusively, suited to evaluate-after-selection implementations and/or implementations where processing capacity is limited since the processing burden is minimized.

According to a second methodology, trackability function evaluation may be performed over a region, either defined in terms of proximity to the current pointing direction or encompassing most or all of the field of view. Potential tracking points are identified by local maxima of the trackability function, optionally also limited to locations with trackability function values above a defined threshold. In this case, choice of a target tracking location may take into consideration factors other than proximity to the selection point, such as the trackability function output value. Thus, a tracking point with a significantly higher trackability function output value may be selected in preference over an alternative tracking point which is slightly closer to the selection point but has a lower trackability function value. The relative weighting between proximity to the selection point and “quality” of the point for tracking is chosen according to details of the specific implementation, and may optionally be definable by the user.

### Region Analysis and Target Suggestion Module

Turning now to region analysis and target suggestion module 32, this may be regarded conceptually as an extension of the aforementioned second methodology of the “snap-to-target” module, but provides a new level of functionality to the system and method of the present invention by indicating to the user one or more suggested trackable image elements prior to target designation. In most preferred implementations, this module may allow target selection of one (or more) of the suggested trackable image elements independent of use of a pointing device, thereby circumventing the various problems of pointing device selection mentioned above.

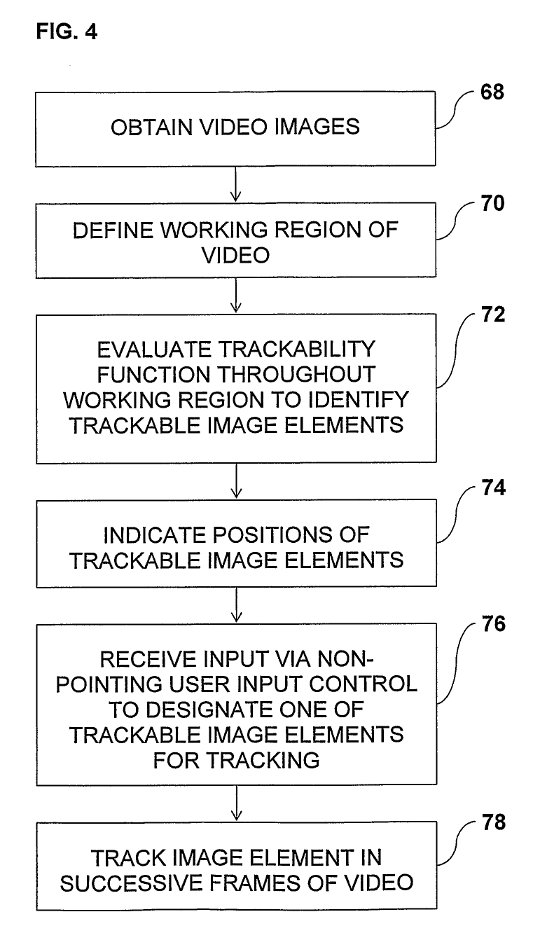

Turning now to FIG. 4 which illustrates operation of this module, this begins at step 68 with obtaining the video images. Then, at step 70, the working region of the video to be used for target suggestion is defined. In some cases, the working region may be fixed as the entire image or a preset large window covering the majority of the image but excluding the peripheral fringes (which may be of lesser significance, depending upon the application). In such cases, step 70 may essentially be omitted. In other cases, the working region is defined according to a given degree of proximity to the current pointing direction, typically as a rectangular or circular window centered at the current pointing direction. Most preferably, the working region may be selected by the user to be either the full area or proximal to the pointing direction, and optionally with user-selected dimensions (e.g., radius).

Then, at step 72, a trackability function is evaluated throughout the working region to identify image elements which are good candidates for tracking. As above, the good candidates for tracking are typically local maxima of a trackability function, preferably satisfying additional conditions such as trackability function values above a given threshold or the like. The trackability function itself may include multiple measures such as “cornemess” and “uniqueness” discussed above, or one measure (e.g., cornerness) may be used alone for determining the local maxima. In the latter case, another function (e.g., uniqueness) may subsequently be applied as a separate filtering criterion for selecting the final good candidates for tracking.

At step 74, positions of suggested trackable image elements are indicated visually to the user on the display 18. In a most preferred implementation as illustrated in FIGS. 7A-7C, this is achieved by superimposing suitable symbols at the suggested locations. In FIG. 7A, the working region was defined as a small circle around the current pointing direction such that only a single suggested tracking location is indicated. In FIG. 7B, a larger circular working region has been used. In FIG. 7C, the entire frame has been used.

Once the suggested trackable image elements have been indicated to the user, the module preferably continues evaluating the real-time video images and updating the suggested tracking locations so that the locations effectively track the corresponding features in successive video images. The repeatability and uniqueness in the appearance of specific features over time and/or the attempt to simultaneously track the features preferably also allows derivation of additional measures indicative of the feature trackability over time. These additional measures help to exclude additional cases of features which are problematic for tracking, such as those lying at depth discontinuities or on occluding boundaries, which are problems which cannot typically be identified using only spatial information from a single frame. The user then provides an input to designate one (or in some applications, a plurality) of the trackable image elements (step 76) and the corresponding image element is then tracked in successive frames of the video (step 78).

It should be noted that, where reference is made to a function being evaluated “throughout”, “over”, or “across” a region, the intention is that the function is evaluated at a plurality of locations substantially spanning the region and sufficiently close to each other to identify gradients in the function. Such language does not necessarily imply evaluation of the function at all possible positions according to the pixel resolution in the source image. Optionally, layered processing may be performed, first at lower spatial frequency (more widely spaced locations) to identify approximate regions of local maxima and then at higher spatial frequency (more closely spaced locations) to locate the maxima more precisely. This approach is referred to as “multi-resolution” or “multi-scale” processing in computer vision terminology. Similarly, where reference is made to continuous evaluation of a function, the implication is that the evaluation is performed substantially in real time on frames from the live video sequence in order to provide the user with apparently continuous real-time adjustments. Such language does not necessary imply processing of each successive frame at the original video input frame rate.

The user selection of step 76 may optionally be performed using a pointing input device. In this case, selection of a suggested trackable image element may be achieved either by pointing and selecting one of the marking symbols directly. Optionally, the selection may be facilitated by adding the “snap-to-target” functionality of module 30 so that actuation of the pointing device selection key results in selection of the suggested target closest to the current pointing direction.

In an alternative particularly preferred set of implementations, the user selection of step 76 is performed using a non-pointing user input control to select one of the at least one suggested trackable image elements. To facilitate this process, the positions of the suggested trackable image elements in the video display may be indicated by displaying an alphanumeric label associated with each of the suggested trackable image elements, as illustrated in FIGS. 7A-7C. In this case, the non-pointing user input control is preferably a keyboard, which may be dedicated or general purpose keyboard, allowing key-pressure selection of an alphanumeric label even if the pointing device is not currently directed towards the desired target. Alternatively, keyed selection can be achieved even without alphanumeric labels. For example, a selector key may be used to cycle through the available suggested targets, even without alphanumeric labels, until the correct target is highlighted for selection by a second control key for tracking purposes.

These non-pointing-user-input options are clearly of particular value where motion of the image and/or user renders precise operation of a pointing device difficult. Instead, the current embodiment of the present invention allows the user to view a label associated with the target on the video display and then to select the desired target by keyed selection, thereby circumventing the need for precise operation of the pointing device. Furthermore, the ongoing processing prior to target designation ensures that the labels move with the corresponding features of the video image, effectively tracking the corresponding image elements. This combination of features renders target selection very much faster and easier than could otherwise be achieved under adverse conditions of motion etc., and ensures that an optimal trackable feature is selected.

Here too, the suggestion process and target designation may be repeated even after active tracking has started, for example, where the quality of the tracking has deteriorated and a more reliably trackable feature must be chosen to avoid imminent failure of the tracking process.

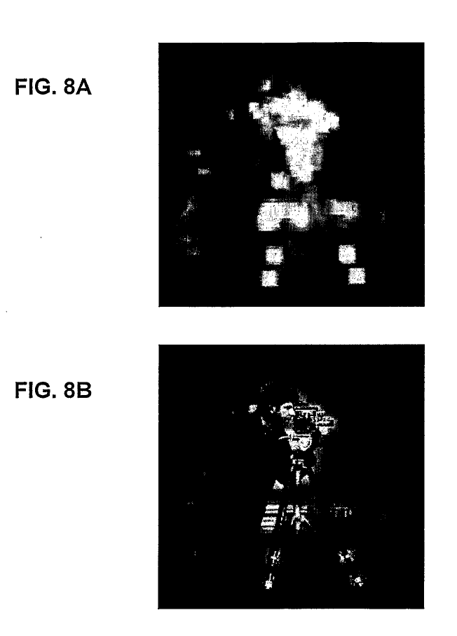

While the preferred implementation of the Region Analysis and Target Suggestion Module described thus far employs labels to designate discrete target locations, it should be appreciated that various other visible indications may be used to indicate the quality of different locations in the video image for tracking purposes. By way of one non-limiting example, FIG. 8A shows an intensity distribution corresponding to the value of a trackability function applied over the entirety of the input frame of FIG. 5. This display could be provided alongside the real-time video display or could momentarily replace the video image on a single display on demand by the user. The location of the bright patches provides a highly intuitive indication to the user of which regions of the video image are good candidates for tracking. In a further non-limiting example, FIG. 8B shows an alternative visible indication wherein the actual video frame is multiplied by the trackability function of FIG. 8A. Here too, the regions which are good candidates for tracking appear bright. In this case, the features of the original video image remain visible in the bright regions, thereby making the image less disruptive to the user as a brief replacement (on demand) for the original video image.

### User Interface

The user is preferably provided a selector control for selecting the tracker mode(s) he or she wishes to activate. Options preferably include one or more of the following: feedback on the current location, bad target lock prevention, suggestion of nearby alternative lock positions, suggestion of alternative targets, or any other modes of operation described above or combinations thereof.

The tracker feedback may be continued after lock: It may suggest alternative lock positions and/or alternative targets while tracking the currently selected target, thus enabling the user to change the decision of lock position on the same target or to change the choice of target altogether.

It will be appreciated that the above descriptions are intended only to serve as examples, and that many other embodiments are possible within the scope of the present invention as defined in the appended claims.

What is Claimed is:

1. A method for assisting a user to designate a target as viewed on a video image displayed on a video display by use of a user operated pointing device, the method comprising the steps of:
(a) evaluating prior to target designation at least one tracking function indicative of a result which would be generated by designating a target at a current pointing direction of the pointing device; and
(b) providing to the user, prior to target designation, an indication indicative of said result.

2. The method of claim 1, wherein said indication is a visible indication presented to the user on the video display.

3. The method of claim 1, wherein said indication is an audible indication.

4. The method of claim 1, wherein said tracking function is a trackability function indicative of the capability of a tracking system to track a target designated at the current pointing direction.

5. The method of claim 1, wherein said tracking function is an object contour selector, and wherein said user-visible indication indicates to the user a contour of an object in the video image which would be selected by designating a target in the current pointing direction.

6. The method of claim 1, wherein said tracking function is a result of a classifier used to identify specific objects appearing within the video image.

7. The method of claim 1, wherein, if said tracking function takes a value in a predefined range of values, said indication indicates to the user an inability to designate a target at a current pointing direction of the pointing device.

8. A method for assisting a user to designate a target as viewed on a video image displayed on a video display by use of a user operated pointing device, the method comprising the steps of:
(a) for at least a region of the video image adjacent to a current pointing direction of the pointing device, evaluating a trackability function at a plurality of locations to derive suggested trackable image elements;
(b) in response to a selection input, designating a current tracking image element within the video image corresponding to one of said suggested trackable image elements proximal to the current pointing position of said pointing device; and
(c) tracking said current tracking image element in successive frames of the video image.

9. The method of claim 8, wherein said trackability function is a score from an object identifying classifier system.

10. The method of claim 8, further comprising, if no suggested trackable image element is derived within said region, preventing designation of a current tracking image element.

11. A method for assisting a user to designate a target as viewed on a video image displayed on a video display by use of a user input device, the method comprising the steps of:
(a) for at least one region of the video image, evaluating a trackability function at a plurality of locations to derive suggested trackable image elements within said region;
(b) if at least one suggested trackable image element has been derived, indicating a position of said at least one suggested trackable image element in the video display;
(c) receiving an input via a user input control to select one of said suggested trackable image elements, thereby designating a current tracking image element.

12. The method of claim 11, wherein said user input control is a non-pointing user input control.

13. The method of claim 11, further comprising, prior to said receiving, tracking said suggested trackable image elements in successive frames of the video image and continuing to indicate the position of said at least one trackable image element in the video image.

14. The method of claim 11, wherein, if a plurality of suggested trackable image elements has been derived, the positions of said plurality of suggested trackable image elements are indicated on the video display.

15. The method of claim 11, wherein said at least one region of the video image is defined as a region satisfying a given proximity condition to a current pointing direction of a pointing device controlled by the user.

16. The method of claim 11, wherein said at least one region of the video image includes substantially the entirety of the video image.

17. The method of claim 11, wherein said indicating a position of said at least one suggested trackable image element in the video display includes displaying an alphanumeric label associated with each of said suggested trackable image elements, and wherein said non-pointing user input control is a keyboard allowing selection of an alphanumeric label.

18. The method of claim 11, further comprising, if no suggested trackable image element is derived within said region, preventing designation of a current tracking image element.
